(19) United States
(12) Patent Application Publication
(10) Pub. No.: US 2004/0128528 A1
(43) Pub. Date: Jul. 1, 2004

(54) Trusted real time clock

(76) Inventor: David I. Poisner, Folsom, CA (US)

Correspondence Address: Jeffrey B. Huter, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/334,267

(22) Filed: Dec. 31, 2002

(51) Int. Cl. G06F 11/30; G06F 1/26

(52) U.S. Cl. 713/200; 713/322

(57) ABSTRACT

Methods, apparatus and computer readable medium are described that attempt increase trust in a wall time provided by a real time clock. In some embodiments, a detector detects activities that may be associated with attacks against the real time clock. Based upon whether the detector detects a possible attack against the real time clock, the computing device may determine whether or not to trust the wall time provided by the real time clock.

### BACKGROUND

An operating system may include a system clock to provide a system time for measuring small increments of time (e.g. 1 millisecond increments). The operating system may update the system clock in response to a periodic interrupt generated by a system such as an Intel 8254 event timer, an Intel High Performance Event Timer (HPET), or a real time clock event timer. The operating system may use the system time to time-stamp files, to generate periodic interrupts, to generate time-based one-shot interrupts, to schedule processes, etc. Generally, the system clock may keep a system time while a computing device is operating, but typically is unable to keep a system time once the computing device is powered off or placed in a sleep state. The operating system therefore may use a reference clock to initialize the system time of the system clock at system start-up and at system wake-up. Further, the system clock tends to drift away from the correct time. Accordingly, the operating system may use a reference clock to periodically update the system time of the system clock.

One such reference clock is a hardware real time clock (RTC). A computing device typically includes an RTC and a battery to power the RTC when the computing device is powered down. Due to the battery power, the RTC is able to maintain a real time or a wall time even when the computing device is powered off or placed in a sleep state, and generally is capable of keeping time more accurately than the system clock. Besides providing an interface for obtaining the wall time, the RTC further provides an interface such as, for example, one or more registers which may be used to set or change the time of the RTC. As is known by those skilled in the art, wall time refers to actual real time (e.g. 12:01 PM, Friday, Dec. 4, 2002) which may comprising, for example, the current seconds, minutes, hours, day of the week, day of the month, month, and year. Wall time derives its name from the time provided by a conventional clock that hangs on a wall and is commonly used to differentiate from CPU time which represents the number of seconds a processor spent executing a process. Due to multi-tasking and multi-processor systems, the CPU time to executed a process may vary drastically from the wall time to execute the process.

The computing device may use the system clock and/or the RTC clock to enforce policies for time-sensitive data. In particular, the computing device may provide time-based access restrictions upon data. For example, the computing device may prevent reading an email message after a period of time (e.g. a month) has elapsed from transmission. The computing device may also prevent reading of source code maintained in escrow until a particular date has arrived. As yet another example, the computing device may prevent assigning a date and/or time to a financial transaction that is earlier than the current date and/or time. However, for these time-based access restrictions to be effective, the computing device must trust the RTC is resistant to attacks that may alter the wall time to the advantage of an attacker.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale.

For example, the dimensions of some elements may be exaggerated relative to other elements for clarity. Further, where considered appropriate, reference numerals have been repeated among the figures to indicate corresponding or analogous elements.

FIG. 1 illustrates an embodiment of a computing device having a real time clock (RTC).

FIG. 2 illustrates an embodiment of a security enhanced (SE) environment that may be established by the computing device of FIG. 1.

FIG. 3 illustrates an example embodiment of a method for responding to a possible attack of the RTC of FIG. 1.

### DETAILED DESCRIPTION

The following description describes techniques for protecting wall time of an RTC from being changed in order to gain unauthorized access to time-sensitive data and/or to perform unauthorized time-sensitive operations. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

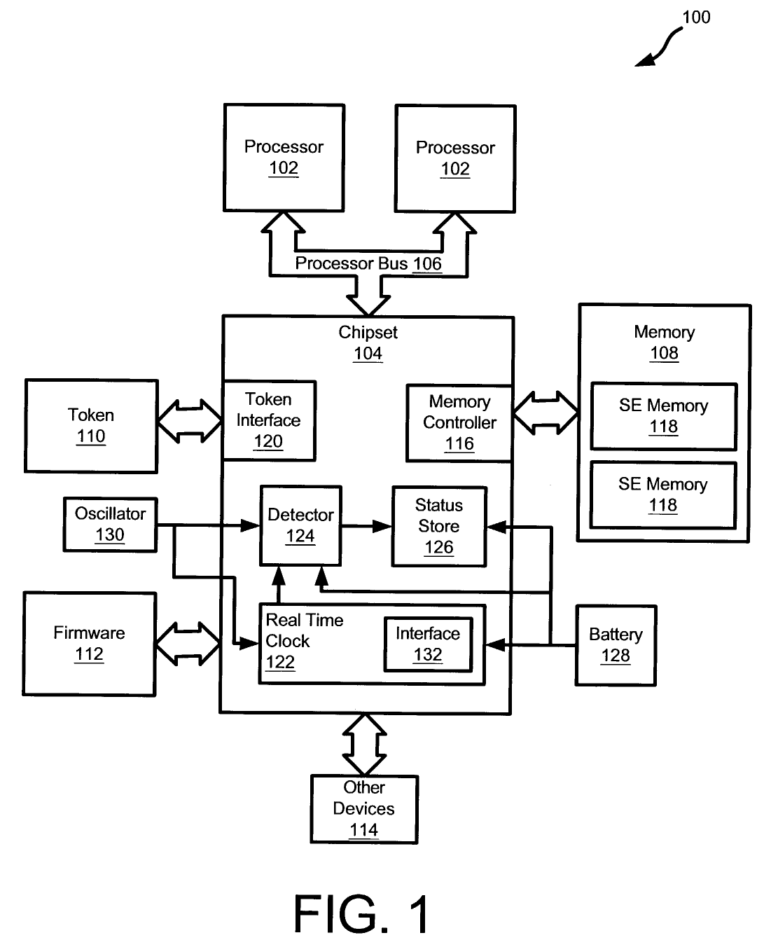

An example embodiment of a computing device 100 is shown in FIG. 1. The computing device 100 may comprise one or more processors 102 coupled to a chipset 104 via a processor bus 106. The chipset 104 may comprise one or more integrated circuit packages or chips that couple the processors 102 to system memory 108, a token 110, firmware 112 and/or other I/O devices 114 of the computing device 100 (e.g. a mouse, keyboard, disk drive, video controller, etc.).

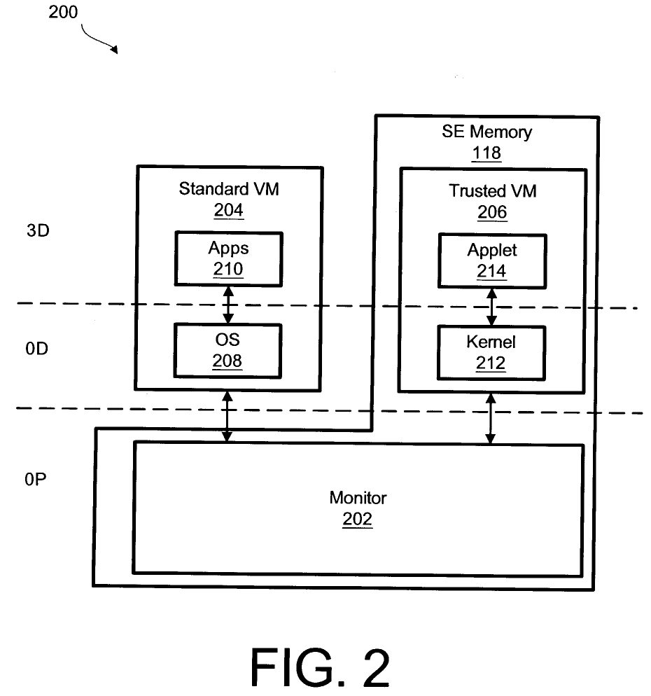

The processors 102 may support execution of a secure enter (SENTER) instruction to initiate creation of a security enhanced (SE) environment such as, for example, the example SE environment of FIG. 2. The processors 102 may further support a secure exit (SEXIT) instruction to initiate dismantling of a SE environment. In one embodiment, the processor 102 may issue bus messages on processor bus 106 in association with execution of the SENTER, SEXIT, and other instructions. In other embodiments, the processors 102 may further comprise a memory controller (not shown) to access system memory 108.

The processors 102 may further support one or more operating modes such as, for example, a real mode, a protected mode, a virtual real mode, and a virtual machine extension mode (VMX mode). Further, the processors 102 may support one or more privilege levels or rings in each of the supported operating modes. In general, the operating modes and privilege levels of a processor 102 define the instructions available for execution and the effect of executing such instructions. More specifically, a processor 102 may be permitted to execute certain privileged instructions only if the processor 102 is in an appropriate mode and/or privilege level.

The firmware 112 may comprises Basic Input/Output System routines (BIOS). The BIOS may provide low-level routines that the processors 102 may execute during system start-up to initialize components of the computing device 100 and to initiate execution of an operating system. The token 110 may comprise one or more cryptographic keys and one or more platform configuration registers (PCR registers) to record and report metrics. The token 110 may support a PCR quote operation that returns a quote or contents of an identified PCR register. The token 110 may also support a PCR extend operation that records a received metric in an identified PCR register. In one embodiment, the token 110 may comprise a Trusted Platform Module (TPM) as described in detail in the Trusted Computing Platform Alliance (TCPA) Main Specification, Version 1.1a, 1 Dec. 2001 or a variant thereof.

The chipset 104 may comprise one or more chips or integrated circuits packages that interface the processors 102 to components of the computing device 100 such as, for example, system memory 108, the token 110, and the other I/O devices 114 of the computing device 100. In one embodiment, the chipset 104 comprises a memory controller 116. However, in other embodiments, the processors 102 may comprise all or a portion of the memory controller 116. The memory controller 116 may provide an interface for other components of the computing device 100 to access the system memory 108. Further, the memory controller 116 of the chipset 104 and/or processors 102 may define certain regions of the memory 108 as security enhanced (SE) memory 118. In one embodiment, the processors 102 may only access SE memory 118 when in an appropriate operating mode (e.g. protected mode) and privilege level (e.g. 0 P).

The chipset 104 may also support standard I/O operations on I/O buses such as peripheral component interconnect (PCI), accelerated graphics port (AGP), universal serial bus (USB), low pin count (LPC) bus, or any other kind of I/O bus (not shown). A token interface 120 may be used to connect chipset 104 with a token 110 that comprises one or more platform configuration registers (PCR). In one embodiment, token interface 120 may be an LPC bus (Low Pin Count (LPC) Interface Specification, Intel Corporation, rev. 1.0, 29 Dec. 1997).

The chipset 104 may further comprise a real time clock (RTC) 122, an RTC attack detector 124, and a status store 126. The RTC 122 may keep a wall time comprising, for example, seconds, minutes, hours, day of the week, day of the month, month, and year. The RTC 122 may further receive power from a battery 128 so that the RTC 122 may keep the wall time even when the computing device 100 is in a powered-down state (e.g. powered off, sleep state, etc.). The RTC 122 may further update its wall time once every second based upon an oscillating signal provided by an external oscillator 130. For example, the oscillator 130 may provide an oscillating signal having a frequency of 32.768 kilo-Hertz, and the RTC 122 may divide this oscillating signal to obtain an update signal having frequency of 1 Hertz which is used to update the wall time of the RTC 122. The RTC 122 may comprise an interface 132 via which the RTC 122 may provide the wall time to the processors 102 and via which the processors 102 may program the RTC 122 and may alter its wall time. The interface 132 may comprise one or more registers which the processors 102 may read from in order to obtain the wall time and which the processors 102 may write to in order to set the wall time. In another embodiment, the processors 102 may provide the interface 132 with commands or messages via the processor bus 106 to obtain the wall time from the RTC 122 and/or to program the wall time of the RTC 122.

The status store 126 may comprise one or more sticky bits that may be used to store an indication of whether a possible RTC attack has been detected. In one embodiment, the sticky bits retain their value despite a system reset and/or system power down. In one embodiment, the sticky bits may comprise volatile storage cells whose state is maintained by power supplied by the battery 128. In such an embodiment, the volatile storage cells may be implemented such that they indicate a possible RTC attack if the current and/or voltage supplied by the battery 128 falls below threshold values. In another embodiment, the sticky bits of the status store 126 may comprise non-volatile storage cells such as a flash memory cells that do not require battery backup to retain their contents across a system reset or a system power down.

The status store 126 may comprise a single sticky bit that may be activated to indicate that a possible RTC attack has been detected, and that may be deactivated to indicate that a possible RTC attack has not been detected. In another embodiment, the status store 126 may comprise a counter comprising a plurality of sticky bits (e.g. 32 sticky bits) to store a count. A change in the count value may be used to indicate a possible RTC attack. In yet another embodiment, the status store 126 may comprise a plurality of bits or counters that may be used to not only identify that a possible RTC attack was detected but may also indicate the type of RTC attack that was detected.

The status store 126 may be further located in a security enhanced (SE) space (not shown) of the chipset 104. In one embodiment, the processors 102 may only alter contents of the SE space by executing one or more privileged instructions. An SE environment, therefore, may prevent processors 102 from altering the contents of the status store 126 via untrusted code by assigning execution of untrusted code to processor rings that are unable to successfully execute such privileged instructions.

The detector 124 of the chipset 104 may detect one or more ways an attacker may launch an attack against the RTC 122 and may report whether a possible RTC attack has occurred. One way an attacker may attack the RTC 122 is to alter the wall time of the RTC 122 via the interface 132 in order to gain unauthorized access to time-sensitive data and/or to perform unauthorized time-sensitive operations. Accordingly, the detector 124 in one embodiment may determine that a possible RTC attack has occurred if the interface 132 has been accessed in a manner that may have changed the wall time. For example, in response to detecting that data was written to registers of the RTC interface 132 that are used to program the wall time of the RTC 122, the detector 124 may update the status store 126 to indicate that a possible RTC attack has occurred. Similarly, the detector 124 may update the status store 126 to indicate a possible RTC attack in response to detecting that the interface 132 has received one or more commands or messages that may cause the RTC 122 to alter its wall time. The detector 124 may further allow some adjustments to the RTC 122 without flagging the change as a possible RTC attack. For example, the detector 124 may allow the wall time to be moved forward or backward by no more than a predetermined amount (e.g. 5 minutes). In such an embodiment, the detector 124 may flag such an adjustment as a possible RTC attack if more than a predetermined number of changes (e.g. 1, 2) have been made during a predetermined interval (e.g. per day, per week, per system reset/power down). The detector 124 may also flag such an adjustment as a possible RTC attack if the adjustment changes the date (e.g. moves the date forward by one calendar day or backward by one calendar day).

Another way an attacker may attack the RTC 122 is to increase or decrease the frequency of the oscillating signal or to remove the oscillating signal from the RTC 122. An attacker may increase the frequency of the oscillating signal to make the RTC 122 run fast and to indicate a wall time that is ahead of the correct wall time. Similarly, an attacker may decrease the frequency of the oscillating signal to make the RTC 122 run slow and to indicate a wall time that is behind the correct wall time. Further, an attacker may remove the oscillating signal or decrease the oscillating signal to zero HZ to stop the RTC 122 from updating its wall time. In one embodiment, the detector 124 may update the status store 126 to indicate a possible RTC attack in response to detecting that the oscillating signal is not present. In another embodiment, the detector 124 may update the status store 126 to indicate a possible RTC attack in response to detecting that the frequency of the oscillating signal has a predetermined relationship to a predetermined range (e.g. less than a value, greater than a value, and/or not between two values). To this end, the detector 124 may comprise a free running oscillator which provides a reference oscillating signal from which the detector 124 may determine whether the frequency of the oscillating signal provided by the oscillator 130 has the predetermined relationship to the predetermined range.

Yet another way the attacker may attack the RTC 122 is to remove the battery 128 from the RTC 122 or to alter electrical characteristics of the power received from the battery 128. The detector 124 may therefore update the status store 126 to indicate a possible RTC attack in response to detecting that one or more electrical characteristics of the received battery power have a predetermined relationship to predetermined electrical characteristics. For example, the detector 124 may detect a possible RTC attack in response to a received battery current having a predetermined relationship to a predetermined current range (e.g. less than a value, greater than a value, not between two values, and/or equal to a value). Similarly, the detector 124 may detect a possible RTC attack in response to a received battery voltage having a predetermined relationship to a predetermined voltage range (e.g. less than a value, greater than a value, not between two values, and/or equal to a value).

An embodiment of an SE environment 200 is shown in FIG. 2. The SE environment 200 may be initiated in response to various events such as, for example, system start-up, an application request, an operating system request, etc. As shown, the SE environment 200 may comprise a trusted virtual machine kernel or monitor 202, one or more standard virtual machines (standard VMs) 204, and one or more trusted virtual machines (trusted VMs) 206. In one embodiment, the monitor 202 of the operating environment 200 executes in the protected mode at the most privileged processor ring (e.g. 0P) to manage security and provide barriers between the virtual machines 204, 206.

The standard VM 204 may comprise an operating system 208 that executes at the most privileged processor ring of the VMX mode (e.g. 0 D), and one or more applications 210 that execute at a lower privileged processor ring of the VMX mode (e.g. 3 D). Since the processor ring in which the monitor 202 executes is more privileged than the processor ring in which the operating system 208 executes, the operating system 208 does not have unfettered control of the computing device 100 but instead is subject to the control and restraints of the monitor 202. In particular, the monitor 202 may prevent untrusted code such as, the operating system 208 and the applications 210 from directly accessing the SE memory 118 and the token 110. Further, the monitor 202 may prevent untrusted code from directly altering the wall time of the RTC 122 and may also prevent untrusted code from altering the status store 126.

The monitor 202 may perform one or more measurements of the trusted kernel 212 such as a cryptographic hash (e.g. Message Digest 5 (MD5), Secure Hash Algorithm 1 (SHA-1), etc.) of the kernel code to obtain one or more metrics, may cause the token 110 to extend a PCR register with the metrics of the kernel 212, and may record the metrics in an associated PCR log stored in SE memory 118. Further, the monitor 202 may establish the trusted VM 206 in SE memory 118 and launch the trusted kernel 212 in the established trusted VM 206.

Similarly, the trusted kernel 212 may take one or more measurements of an applet or application 214 such as a cryptographic hash of the applet code to obtain one or more metrics. The trusted kernel 212 via the monitor 202 may then cause the token 110 to extend a PCR register with the metrics of the applet 214. The trusted kernel 212 may further record the metrics in an associated PCR log stored in SE memory 118. Further, the trusted kernel 212 may launch the trusted applet 214 in the established trusted VM 206 of the SE memory 118.

In response to initiating the SE environment 200 of FIG. 2, the computing device 100 further records metrics of the monitor 202 and hardware components of the computing device 100 in a PCR register of the token 110. For example, the processor 102 may obtain hardware identifiers such as, for example, processor family, processor version, processor microcode version, chipset version, and token version of the processors 102, chipset 104, and token 110. The processor 102 may then record the obtained hardware identifiers in one or more PCR register.

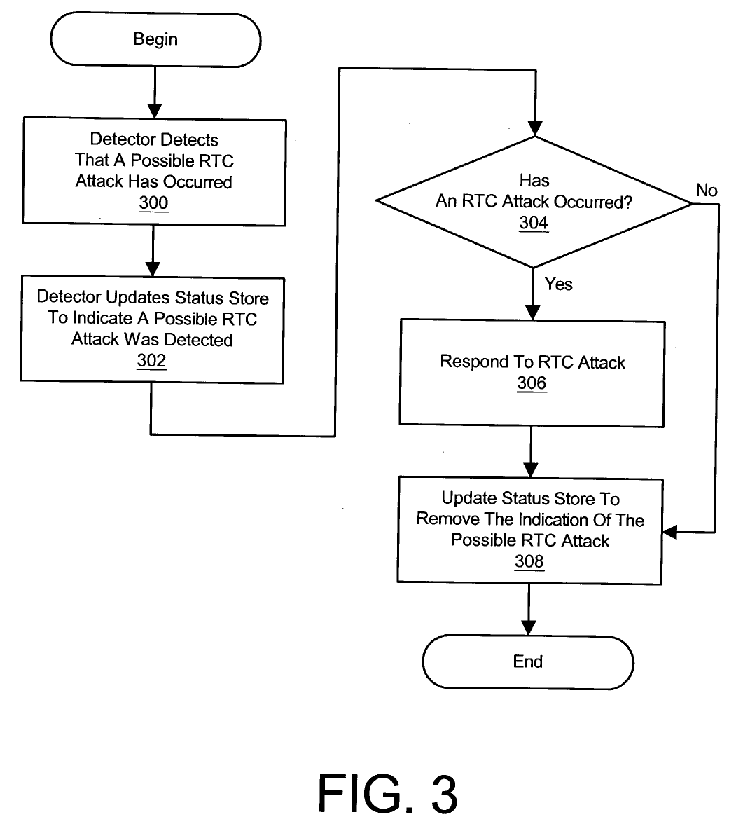

An example method of responding to a possible attack against the RTC 122 is shown in FIG. 3. In block 300, the detector 124 may detect that a possible RTC attack has occurred. For example, the detector 124 may determine that a possible RTC attack has occurred in response to determining that power supplied by the battery 128 has a predetermined relationship to a predetermined range, that the frequency of the oscillating signal has a predetermined relationship to a predetermined range, or that the RTC interface 132 has been accessed in a manner that may have changed the wall time of the RTC 122. The detector 124 in block 302 may update the status store 126 to indicate a possible RTC attack. In one embodiment, the detector 124 may indicate a possible RTC attack by activating a bit of the status store 126. In another embodiment, the detector 124 may indicate a possible RTC attack by updating (e.g. incrementing, decrementing, setting, resetting) a count value of the status store 126.

The monitor 202 in block 304 may determine whether an RTC attack has occurred based upon the status store 126. In one embodiment, the monitor 202 may determine that an RTC attack has occurred in response to a bit of the status store 126 being active. In another embodiment, the monitor 202 may determine that an RTC attack has occurred in response a count value of the status store 126 not having a predetermined relationship (e.g. equal) to an expected count value. For example, the monitor 202 may maintain an expected count value that is retained through system resets, system power downs, or SE environment tear downs. The monitor 202 may compare the count value of the status store 126 with the expected count value to determine whether the detector 124 has detected one or more possible RTC attacks since the monitor 202 last updated its expected count value.

In addition to the status store 126, the monitor 202 may also determine whether an RTC attack has occurred based upon a trust policy. For example, the status store 126 may indicate that the wall time of the RTC 122 was changed via the RTC interface 132. However, the trust policy may allow the processors 102 to move the wall time forward or backward by no more than a predetermined amount (e.g. 5 minutes) without it being defined as an RTC attack. While the trust policy may allow the wall time to be adjusted, the trust policy may define such an adjustment as an RTC attack if more than a predetermined number of adjustments (e.g. 1, 2) are made via the RTC interface 132 during a predetermined interval (e.g. per day, per week, per system reset/power down). The trust policy may further define an adjustment via the RTC interface 132 as a RTC attack if the adjustment results in a change to the date of the RTC 122 (e.g. moving the wall time forward by one calendar day or backward by one calendar day).

In block 306, the monitor 202 may respond to the detected RTC attack. In one embodiment, the monitor 202 may respond based upon a trust policy. In one embodiment, the trust policy may indicate that the SE environment 200 does not contain time-sensitive data and/or is not performing time-sensitive operations. Accordingly, the monitor 202 may simply ignore the possible RTC attack. In another embodiment, the policy may indicate that the monitor 202 is to reset the computing device 100 or tear down the SE environment 200 in response to detecting certain types of RTC attacks such as, for example, detecting that the frequency of the oscillating signal has a predetermined relationship to a predetermined range or that the power of the battery has a predetermined relationship to a predetermined range. In yet another embodiment, the policy may indicate that the monitor 202 is to prevent access to time-sensitive data and/or time-sensitive operations until the correct wall time is established. In one embodiment, the monitor 202 may communicate with a trusted time server via a network connection in order to establish the correct wall time. In another embodiment, the monitor 202 may provide an interested party an opportunity to verify and/or change the wall time of the RTC 122. For example, the monitor 202 may provide a user of the computer device 100 and/or the owner of the time-sensitive data with the wall time of the RTC 122 and may ask the user and/or owner to verify the wall time is correct and/or to update the wall time to the correct wall time.

The monitor 202 in block 308 may update the status store 126 to remove the indication of a possible RTC attack. In one embodiment, the monitor 202 may deactivate a bit of the status store 126 in order to clear the indication of a possible RTC attack. In another embodiment, the monitor 202 may update its expected count value and/or a count value of the status store 126 such that the expected count value and the count value of the status store 126 have a relationship that indicates that no RTC attack has been detected.

The computing device 100 may perform all or a subset of the example method of FIG. 3 in response to executing instructions of a machine readable medium such as, for example, read only memory (ROM); random access memory (RAM); magnetic disk storage media; optical storage media; flash memory devices; and/or electrical, optical, acoustical or other form of propagated signals such as, for example, carrier waves, infrared signals, digital signals, analog signals. Furthermore, while the example method of FIG. 3 is illustrated as a sequence of operations, the computing device 100 in some embodiments may perform various illustrated operations of the method in parallel or in a different order.

While certain features of the invention have been described with reference to example embodiments, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. For use with a real time clock that keeps a wall time, a method comprising
detecting a possible attack against the real time clock, and
updating a status store to indicate a possible attack against the real time clock.

2. The method claim 1 further comprising detecting a possible attack against the real time clock in response to determining that one or more electrical characteristics of power received from a battery associated with the real time clock has a predetermined relationship to one or more predetermined electrical characteristics.

3. The method of claim 1 further comprising detecting a possible attack against the real time clock in response to detecting one or more accesses to an interface of the real time clock that may alter the wall time kept by the real time clock.

4. The method of claim 1 further comprising detecting a possible attack against the real time clock in response to detecting a frequency of an oscillator associated with the real time clock has a predetermined relationship to a predetermined range.

5. The method of claim 1 further comprising
activating a bit of the status store in response to detecting a possible attack against the real time clock, and
preventing untrusted code from deactivating the bit of the status store.

6. The method of claim 1 further comprising
updating a count of a counter of the status store in response to detecting a possible attack against the real time clock, and
preventing untrusted code from altering the count of the counter.

7. The method of claim 1 further comprising determining that a possible attack has not occurred in response to determining that an adjustment of the wall time has a predetermined relationship to a predetermined range.

8. The method of claim 1 further comprising determining that a possible attack has occurred in response to determining that more than a predetermined number of adjustments have been made to the wall time.

9. The method of claim 1 further comprising determining that a possible attack has occurred in response to determining that an adjustment to the wall time of the real time clock changed a date of the wall time.

10. A chipset comprising
a real time clock to keep a wall time,
a status store to indicate whether a possible attack against the real time clock was detected, and
a detector to detect a possible attack against the real time clock and to update the status store based upon whether a possible attack against real time clock was detected.

11. The chipset of claim 10 wherein the detector detects a possible attack against the real time clock in response to determining that one or more electrical characteristics of power received from a battery associated with the real time clock has a predetermined relationship to one or more predetermined electrical characteristics.

12. The chipset of claim 10 wherein
the real time clock comprises an interface to program the wall time, and
the detector detects a possible attack against the real time clock in response to detecting one or more programming accesses to the interface of the real time clock.

13. The chipset of claim 10 wherein
the real time clock keeps the wall time based upon an oscillating signal received from an external oscillator, and
the detector detects a possible attack against the real time clock in response to detecting a frequency of the oscillating signal has a predetermined relationship to a predetermined range.

14. The chipset of claim 10 wherein
the status store comprises a sticky bit that retains its value during a system reset and a system power down and that after being activated may only be deactivated by a trusted code of a security enhanced environment, and
the detector activates the sticky bit of the status store in response to detecting a possible attack against the real time clock.

15. The chipset of claim 10 wherein
the status store comprises a counter comprising a plurality of sticky bits that retain their value during a system reset and a system power down and that may only be updated by the detector and trusted code of a security enhanced environment, and
the detector updates the counter of the status store in response to detecting a possible attack against the real time clock.

16. A computing device comprising
memory to store a plurality of instructions,
a real time clock to provide a wall time,
a processor to obtain the wall time from the real time clock in response to processing the plurality of instructions, and
a detector to indicate to the processor whether a possible attack against the real time clock has been detected.

17. The computing device of claim 16 further comprising a status store to indicate whether a possible attack against the real time clock was detected, wherein the detector updates the status store to indicate a possible attack against the real time clock.

18. The computing device of claim 16 further comprising a sticky bit to indicate whether a possible attack against the real time clock was detected, wherein the detector activates the sticky bit to indicate a possible attack against the real time clock.

19. The computing device of claim 18 wherein the sticky bit is located in a security enhanced space that prevents untrusted code from deactivating the sticky bit.

20. The computing device of claim 16 further comprising an external oscillator to provide the real time clock with an oscillating signal, wherein
the real time clock keeps the wall time based upon the oscillating signal of the external oscillator, and
the detector indicates a possible attack against the real time clock in response to determining that a frequency of the oscillating signal has a predetermined relationship to a predetermined range.

21. A machine-readable medium comprising a plurality of instructions that in response to being executed result in a computing device
determining that an attack against a real time clock of the computing device has been detected, and
responding to the attack against the real time clock.

22. The machine-readable medium of claim 21 wherein the plurality of instructions further result in the computing device responding to the attack by requesting an interested party to confirm that a wall time of the real time clock is correct.

23. The machine-readable medium of claim 21 wherein the plurality of instructions further result in the computing device responding to the attack by preventing access to time-sensitive data.

24. The machine-readable medium of claim 21 wherein the plurality of instructions further result in the computing device responding to the attack by preventing time-sensitive operations.

25. The machine-readable medium of claim 21 wherein the plurality of instructions further result in the computing device determining that an attack has been detected based upon whether a status bit associated with the real time clock has been activated.

26. The machine-readable medium of claim 21 wherein the plurality of instructions further result in the computing device determining that an attack has been detected based upon whether a counter associated with the real time clock has an expected count value.

27. The machine-readable medium of claim 21 wherein the plurality of instructions further result in the computing device determining that an attack has been detected based upon a status store associated with the real time clock and a trust policy.

28. The machine-readable medium of claim 21 wherein the plurality of instructions further result in the computing device determining that an attack has not been detected in response to determining that an adjustment of the wall time of the real time clock has a predetermined relationship to a predetermined range.

29. The machine-readable medium of claim 21 wherein the plurality of instructions further result in the computing device determining that an attack has been detected in response to determining that more than a predetermined number of adjustments have been made to the wall time of the real time clock.

30. The machine-readable medium of claim 21 wherein the plurality of instructions further result in the computing device determining that an attack has been detected in response to determining that an adjustment to the wall time of the real time clock changed a date of the wall time.
